(19) United States
(12) Patent Application Publication
(10) Pub. No.: US 2013/0055905 A1
(43) Pub. Date: Mar. 7, 2013

(54) EASY OPERATION FILTER FOR A COFFEE MACHINE

(71) Applicants: Weijun ZHONG, Zhangzhou (CN); Wan-chun YANG, Kaohsiung City (TW)

(72) Inventors: Weijun ZHONG, Zhangzhou (CN); Wan-chun YANG, Kaohsiung City (TW)

(73) Assignee: TSANN KUEN (ZHANG ZHOU) ENTERPRISE CO., LTD., Zhangzhou (CN)

(21) Appl. No.: 13/604,263

(22) Filed: Sep. 5, 2012

(30) Foreign Application Priority Data
Sep. 5, 2011 (CN) 201120332469.7

(51) Int. Cl. A47J 31/06

(52) U.S. Cl. 99/323

(57) ABSTRACT

An easy operation filter for a coffee machine, which is placed in the output of drip coffee machines operated at normal atmospheric pressure, including an upper body and a lower body shaped like a clam; wherein the lower body is disposed with an accommodating room faced up, the accommodating room is disposed with a detachable coffee box inside; a hinge to make the upper body and lower body keep open and a lock switch of quick locking and unlocking are disposed between the upper body and the lower body; an user-friendly handle is disposed in the coffee box. During the operation of the filter, whether to press the button to open the upper body, hold the handle to load the coffee box or close the upper body and lower body, it has concise steps, clear operation direction, making the operation of the filter simple and fast.

### TECHNICAL FIELD OF THE INVENTION

The present invention relates to a filter for a coffee machine.

### BACKGROUND OF THE INVENTION

The existing filter for an ordinary coffee machine includes an upper body and a lower body of detachable, and a coffee box positioned therein;

when actually used, get the coffee box out of the upper body and the lower body of detached, put in the coffee powder and then put the coffee box back, finally start the machine for filter. How to design a filter with humanization design to making it easy and convenient to open or close the upper body and lower body or to get the coffee box or put it back is the necessary requirement for the coffee machine.

### SUMMARY OF THE INVENTION

For the foregoing requirements, the present invention is provided with an easy operation filter for a coffee machine. The technical proposal of the present invention is as below:

An easy operation filter for a coffee machine, which is placed in the output of drip coffee machines operated at normal atmospheric pressure, includes an upper body and lower body shaped like a clam; the lower body is disposed with an accommodating room faced up, the accommodating room is disposed with a detachable coffee box inside; a hinge to make the upper body and lower body keep open and a lock switch of quick locking and unlocking are disposed between the upper body and the lower body; a user-friendly handle is disposed in the coffee box.

As the preferred technical proposal, it can be improved in these perspectives as below:

In anther preferred embodiment, the coffee box is cup-shaped of rotationally symmetric, the handle is the extended bar from the edge of the entrance of the coffee box of cup-shaped.

In anther preferred embodiment, the present invention includes two handles, which are rotationally symmetric about the axis of the coffee box.

In anther preferred embodiment, a torsional spring is disposed in the axis of rotation of the hinge.

In anther preferred embodiment, the lock switch includes a button controlling on/off of coffee machine by vertical pressure, the button is disposed on the external periphery of the lower body, and the upper body is disposed with a bolt corresponding to the button for locking the button in the vertical direction.

In anther preferred embodiment, when the upper body and lower body are closed, the coffee box between the above two are coaxial and rotationally symmetric; the lock switch and the connection portion of the upper body and lower body are rotationally symmetric in 180 degrees about the connection portion of the upper body and lower body.

In anther preferred embodiment, the coffee box is suitable for the shape of the coffee capsule.

The advantageous effects of the present invention are as below:

1. During the operation of the filter, whether to press the button to open the upper body, hold the handle to load the coffee box or close the upper body and lower body, it has concise steps, clear operation direction, making the operation of the filter simple and fast.

2. The button is pressed in vertical direction, with the bolt locked to the button in the vertical direction, it makes good use of the supporting the coffee machine received. The operation is reliable and safe.

3. The coffee box is applied with a double handles of rotationally symmetric, making it without limited by the hand and the coffee machine position to get the coffee box out or put it in, making it more convenient and fast.

4. The technical proposal is suitable for the coffee capsule.

### BRIEF DESCRIPTION OF THE DRAWINGS

The present invention will be further described with the drawings and embodiments.

FIG. 1 illustrates the explosive view of the first embodiment of the present invention;

FIG. 2 illustrates the structure of the first embodiment of FIG. 1 in usage;

FIG. 3 illustrates the structure of the box of the second embodiment of the present invention.

### DETAILED DESCRIPTION OF THE EMBODIMENTS

The first embodiment:

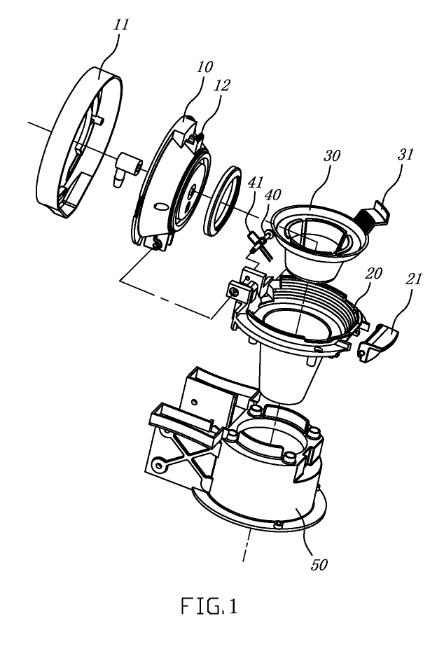

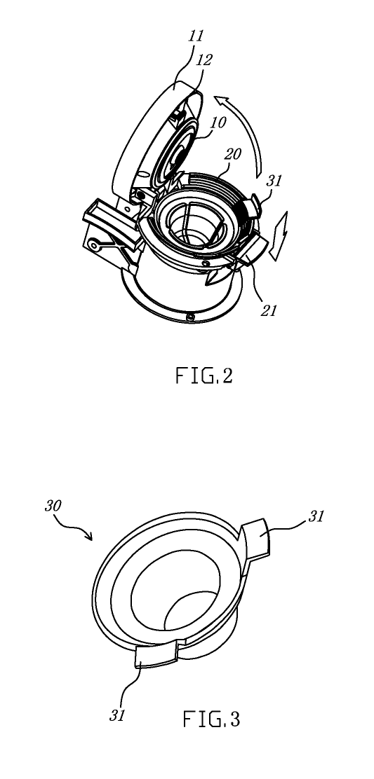

Referring to FIG. 1, the explosive view of the first embodiment of the present invention. FIG. 2 illustrates the structure of the first embodiment in usage; combining with the FIG. 1 and FIG. 2:

The filter for a coffee machine, which is placed in the output of drip coffee machines operated at normal atmospheric pressure, includes an upper body 10 and a lower body 20 shaped like a clam; a hinge 40 is disposed between the upper body 10 and the lower body 20 to keep the two normally open. The hinge 40 includes an axis 41 and a torsional spring 42, the upper body and lower body are pivot jointed in the external periphery through the axis 41; and the torsional spring 42 is passed thorough the axis 41, the two stress ends separately work on the upper body 10 and the lower body 20. so with the effect of the torsional spring 42, if without other acting force between the upper body 10 and the lower body 20, the upper body 10 keeps open relative to the lower body 20 on the axis 41.

A coffee box 30 is placed inside the lower body 20. The coffee box is placed or fetched from the entrance of the lower body 20; when the upper body and lower body are closed, the coffee box 30 and the upper body 10 and lower body 20 are coaxial and rotationally symmetric. The coffee box 30 is cup-shaped; the handle 31 is extended from the edge of the entrance of the coffee box 31.

A button 21 is disposed in the external periphery of the lower body 20. When the button 21 is pressed in the lower body 20, it overturns relative to the lower body 20; the shaft is vertical to the axis of the lower body 20. The button works by pressed in the down direction vertically; corresponding to the button 21, the upper body is disposed with a bolt 12, which is locked to the button 21 in the vertical direction.

In actually usage, the present invention is most suitable to the coffee capsule. As the capacity of the coffee powder, the powder density and the powder shape inside the coffee capsule are consistent; it has better consistent in the tasty, the consistency and the output of the coffee. The filtering is completed inside the coffee capsule, which will not produce extra pollution to the machine. It is easy and fast to replace the coffee capsule. The coffee box 30 is loaded with a coffee capsule each time with the convenience of the filter of the present invention. When the upper body 10 and the lower body 20 are closed and the coffee box 30 is loaded with coffee capsule inside, hot water from the upper body 10 drips to the coffee box 30, flows to the coffee capsule to filter the coffee powder and then flows through the lower body 20 to the coffee container toward the base 50.

In this embodiment, the button 21 and the connection portion of the upper body and lower body, that is the axis 41, are rotationally symmetric in 180 degrees about the rotation axis of the coffee box 30. With this position, the torque of torsional spring relative to the button 21 is the smallest and it is vertical to the plane, so the upper body 10 can be locked to the lower body 20 in single point effectively.

Combined with the FIG. 2, it illustrates the operation of this embodiment: the normal status of the coffee machine is that the upper body 10 with the cover 11 is locked to the lower body 20, and the coffee box 30 is placed inside. Firstly press the button 21 in the direction of the thick hollow arrow to unlock the bolt 12, the upper body 10 with the cover 11 springs up along the direction of the thin hollow arrow, making the upper body and lower body open like a clam. So people can get the coffee box through the handle 31 and put coffee powder in.

When the coffee box 30 is loaded with the coffee capsule, hand the handle 31 to put the coffee box 30 to the lower body 20, finally press the cover 11 with the upper body 10 down from the cover 11 along the opposite of the thin hollow arrow until the bolt 12 is locked by the button 21. That is a complete operation cycle. People can start the machine to filter. When completing the filter, repeat the above operation to replace the coffee capsule. The whole operation, whether to press the button 21 to open the upper body, hold the handle to load the coffee box or close the upper body and lower body, it has concise steps, clear operation direction, making the operation of the filter simple and fast. In another hand, the button is pressed in vertical direction, with the bolt locked to the button in the vertical direction, it makes good use of the supporting the coffee machine received. The operation is reliable and safe.

The second embodiment:

Referring to FIG. 3 with the structure of the coffee box of the second embodiment. The upper body and lower body of this embodiment is the same as the first embodiment. The shape of the coffee box 30 is different. Referring to the figure of this embodiment, the coffee box 30 has two handles 31, which are rotationally symmetric about the axis of the coffee box 30. When the coffee box 30 is placed in the lower body 20 in the FIG. 2, either right-handed or left-handed can easily catch the coffee box 30. It is not limited by the hand and the coffee machine position to get the coffee box 30 out or put it in, making it more convenient and fast.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

What is claimed is:

1. An easy operation filter for a coffee machine, which is placed in the output of drip coffee machines operated at normal atmospheric pressure, including an upper body and a lower body shaped like a clam; wherein the lower body is disposed with an accommodating room faced up, the accommodating room is disposed with a detachable coffee box inside; a hinge to make the upper body and lower body keep open and a lock switch of quick locking and unlocking are disposed between the upper body and the lower body; a user-friendly handle is disposed in the coffee box.

2. An easy operation filter for a coffee machine according to the claim 1, wherein the coffee box is cup-shaped of rotationally symmetric, the handle is the extended bar from the edge of the entrance of the coffee box of cup-shaped.

3. An easy operation filter for a coffee machine according to the claim 2, wherein includes two handles, which are rotationally symmetric about the axis of the coffee box.

4. An easy operation filter for a coffee machine according to the claim 1, wherein a torsional spring is disposed in the axis of rotation of the hinge.

5. An easy operation filter for a coffee machine according to the claim 1, wherein the lock switch including a button controlling on/off of coffee machine by vertical pressure, the button is disposed on the external periphery of the lower body, the upper body is disposed with a bolt corresponding to the button for locking the button in the vertical direction.

6. An easy operation filter for a coffee machine according to the claim 1, wherein when the upper body and lower body are closed, the coffee box between the above two are coaxial and rotationally symmetric; the lock switch and the connection portion of the upper body and lower body are rotationally symmetric in 180 degrees about the connection portion of the upper body and lower body.

7. An easy operation filter for a coffee machine according to the claim 1, wherein the coffee box is suitable for the shape of the coffee capsule.
